(19) United States
(12) Patent Application Publication
(10) Pub. No.: US 2005/0010012 A1
(43) Pub. Date: Jan. 13, 2005

(54) Method for producing functionalized oligomeric silsesquioxanes and the use of the same

(76) Inventors: Carsten Jost, Marl (DE); Adolf Kuhnle, Marl (DE); Hendrikus Cornelis Louis Abbenhuis, Nuenen (NL)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/494,043

(22) PCT Filed: Nov. 13, 2002
(86) PCT No.: PCT/EP02/12678

(51) Int. Cl. C08G 77/04

(52) U.S. Cl. 528/34; 528/12

(57) ABSTRACT

The invention relates to a process for preparing functionalized oligomeric silsesquioxanes by reacting incompletely condensed oligomeric silsesquioxanes with alkoxysilanes and also to their use for further derivatizations, for the synthesis of catalysts and their starting compounds, and for the synthesis and modification of polymers.

The invention relates to a process for preparing functionalized oligomeric silsesquioxanes and also to their use for further derivatizations, for the synthesis of catalysts and their starting compounds, and for the synthesis and modification of polymers.

Oligomeric silsesquioxanes can be used for synthesizing or modifying polymers with a broad field of application. The polymers resulting therefrom may find use, for example, in coatings and adhesives, in moldings of polymer, in fibers or packaging materials. The ability to prepare the silsesquioxanes in a great breadth of variation in terms of their structure means that the properties of the polymers which can be prepared from silsesquioxanes and/or can be modified with them can be influenced over a wide range. Numerous thermal and mechanical properties of polymers can be enhanced by the blending, grafting, addition copolymerization or copolycondensation of silsesquioxanes: examples of these properties here include the various moduli, the temperature stability, the adhesion properties for a multiplicity of materials, the oxidation stability, the scratch resistance, and the tensile strength.

More recently metal-containing silsesquioxanes have also gained increasing significance in terms of their possible use as catalysts (Chem. Eur. J. 2000, 6, 25-32). Feher et al. (J. Am. Chem. Soc. 1989, 111, 1741-8) describe the synthesis of variously functionalized oligomeric silsesquioxanes of structure 1 (X=functional group or functionalized radical, R=hydrocarbon radical) by so-called corner capping of the oligomeric silsesquioxane-trisilanols of structure 2 with functionalized trichlorosilanes XSiCl₃ in the presence of an amine. Unfortunately this produces the triply stoichiometric amount of ammonium chlorides as a byproduct of the condensation reaction of the trisilanol 2 with the trichlorosilanes XSiCl₃. Additionally, because of the sensitivity of the trichlorosilanes to hydrolysis, it is necessary to work in the strict absence of moisture. The use of trichlorosilanes is also a disadvantage on account of the fact that these compounds are in many cases relatively expensive. The analogous trialkoxysilanes XSi(OR′)₃ are often available at more favorable cost than the trichlorosilanes. 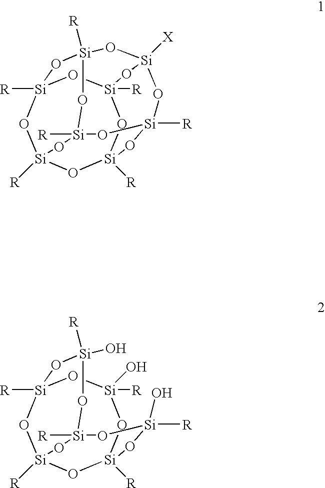
Lichtenhan et al. (U.S. Pat. No. 5,484,867; Comments Inorg. Chem. 1995, 17, 115-30; Macromolecules 1996, 29, 7302-4; Macromolecules 1995, 28, 8435-7) also describe the synthesis of functionalized oligomeric silsesquioxanes of structure 1 by corner capping of the respective trisilanol precursors 2 with the trichlorosilane building blocks XSiCl₃ using an amine base, as a result of which it is possible introduce silanol, silane, acrylic, olefin, epoxy, halogen, alcohol, amine, and isocyanate functions into the oligomeric silsesquioxane molecule by way of the functional group X.

The methods known from the literature to date require the unfavorable use of the expensive trichlorosilane building blocks XSiCl₃ using an amine base (Appl. Organomet. Chem. 1999, 13, 213-26) and are necessarily followed by the inconvenient separation of the ammonium chloride salt which is formed. Working with trichlorosilanes, moreover, requires the strict exclusion of moisture and is therefore likewise very inconvenient.

It was an object of the invention, therefore, to provide an efficient process for preparing functionalized oligomeric silsesquioxanes by reacting incompletely condensed silsesquioxanes with alkoxysilanes which is suitable for general use. A particular object of the present process was to provide a simple and efficient process for preparing functionalized oligomeric silsesquioxanes of structure 1 by corner capping the trisilanols of structure 2 (X=functional group or functionalized radical, R=hydrocarbon radical) which is accomplished without chlorosilanes in the reaction.

Surprisingly it has been found that functionalized oligomeric silsesquioxanes can be prepared in a simple way by reacting incompletely condensed oligomeric silsesquioxanes with alkoxysilanes. In particular, functionalized silsesquioxanes of structure 1 can be synthesized by corner capping incompletely condensed oligomeric silsesquioxanes of structure 2 with alkoxysilane monomers XSi(OR′)₃ under base catalysis, with X being a hydrogen, oxy, hydroxyl, alkoxy, carboxyl, silyl, silyloxy, halogen, epoxy, ester, fluoroalkyl, isocyanate, acrylate, methacrylate, nitrile, amino, phosphine group, and—where possible—these radicals X may in turn be further functionalized, and/or a substituted or unsubstituted alkyl, cycloalkyl, alkenyl, cycloalkenyl, alkynyl, cycloalkynyl, aryl, heteroaryl radical which is functionalized with oxy, hydroxyl, alkoxy, carboxyl, silyl, silyloxy, halogen, epoxy, ester, fluoroalkyl, isocyanate, acrylate, methacrylate, nitrile, amino, phosphine groups. R is a hydrogen atom, a substituted or unsubstituted alkyl, cycloalkyl, alkenyl, cycloalkenyl, alkynyl, cycloalkynyl, aryl, heteroaryl radical or in all or some cases a group X. R′ is a hydrogen atom, a substituted or unsubstituted alkyl, cycloalkyl, alkenyl, cycloalkenyl, alkynyl, cycloalkynyl, aryl, heteroaryl radical.

The present invention accordingly provides a process for preparing functionalized oligomeric silsesquioxanes which comprises reacting incompletely condensed oligomeric silsesquioxanes with alkoxysilanes.

Likewise provided by the present invention is the use of the functionalized oligomeric silsesquioxanes prepared as claimed in claims 1 to 20 for further derivatizations, for the synthesis of catalysts and their starting compounds, and for the synthesis and/or modification of polymers.

As compared with the known literature methods which involve chlorosilane reagents the present invention has the advantage that, with alkoxysilanes, inexpensive reagents are employed, thereby increasing the economics of the synthesis process for functionalized oligomeric silsesquioxanes. Also unnecessary is both working under strict moisture exclusion and the separation and disposal of the stoichiometric amounts of ammonium chloride salts formed in the hitherto customary reaction of silanols with chlorosilanes, especially trichlorosilanes XSiCI₃, and amines. By avoiding large quantities of ammonium salts it is possible with the process of the invention to avoid the need for expensive disposal of these salts as waste.

By means of the process of the invention, therefore, an efficient, innovative route has been opened up to the preparation of functionalized oligomeric silsesquioxanes by base-catalyzed corner capping of incompletely condensed oligomeric silsesquioxanes with alkoxysilanes. The provision of an efficient, cost-effective preparation process for functionalized oligomeric silsesquioxanes is of great significance, since these compounds can be used not only for further derivatizations, for the synthesis of catalysts and their starting compounds, but also, by copolymerization, grafting, and blending, for the synthesis and modification of a multiplicity of polymers.

The process of the invention is described by way of example below, without any intention that the process should be restricted thereto.

The process of the invention for preparing functionalized oligomeric silsesquioxanes comprises reacting incompletely condensed oligomeric silsesquioxanes with alkoxysilanes. The reaction of the incompletely condensed oligomeric silsesquioxanes with alkoxysilanes takes place preferably under base catalysis. As alkoxysilanes it is preferred to use compounds of the formula XₘSi(OR′)ₙ, where X is a hydrogen, oxy, hydroxyl, alkoxy, carboxyl, silyl, silyloxy, halogen, epoxy, ester, fluoroalkyl, isocyanate, acrylate, methacrylate, nitrile, amino, phosphine group, where—where possible—these radicals X can in turn be further functionalized, and/or a substituted or unsubstituted alkyl, cycloalkyl, alkenyl, cycloalkenyl, alkynyl, cycloalkynyl, aryl, heteroaryl radical which is functionalized with oxy, hydroxyl, alkoxy, carboxyl, silyl, silyloxy, halogen, epoxy, ester, fluoroalkyl, isocyanate, acrylate, methacrylate, nitrile, amino, phosphine groups, R′ can be a hydrogen atom, a substituted or unsubstituted alkyl, cycloalkyl, alkenyl, cycloalkenyl, alkynyl, cycloalkynyl, aryl, heteroaryl radical, it being possible for the radicals R′ to be identical or different and for m and n to adopt values of 1 to 3, with the proviso that the sum of m and n is 4. Particular preference is given to using alkoxysilanes of the formula XSi(OR′)₃, especially those in which X is not a halogen or a hydroxyl, alkoxy or silyloxy radical.

The process of the invention is particularly suitable for preparing functionalized oligomeric silsesquioxanes of structure 1 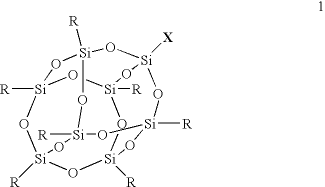
by reaction of incompletely condensed oligomeric silsesquioxanes of structure 2 as reactants 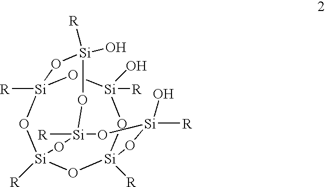
with alkoxysilanes XₘSi(OR′)ₙ, preferably XSi(OR′)₃, under base catalysis,
where X is a hydrogen, oxy, hydroxyl, alkoxy, carboxyl, silyl, silyloxy, halogen, epoxy, ester, fluoroalkyl, isocyanate, acrylate, methacrylate, nitrile, amino or phosphine group, and—where possible—these radicals X may in turn be further functionalized, and/or a substituted or unsubstituted alkyl, cycloalkyl, alkenyl, cycloalkenyl, alkynyl, cycloalkynyl, aryl, heteroaryl radical which is functionalized with oxy, hydroxyl, alkoxy, carboxyl, silyl, silyloxy, halogen, epoxy, ester, fluoroalkyl, isocyanate, acrylate, methacrylate, nitrile, amino, phosphine groups. R can be hydrogen atom, a substituted or unsubstituted alkyl, cycloalkyl, alkenyl, cycloalkenyl, alkynyl, cycloalkynyl, aryl, heteroaryl radical or in all or some cases a group X, and R′ is a hydrogen atom, a substituted or unsubstituted alkyl, cycloalkyl, alkenyl, cycloalkenyl, alkynyl, cycloalkynyl, aryl, heteroaryl radical.

The process of the invention for functionalizing incompletely condensed oligomeric silsesquioxanes is not restricted to substrates of structure 2, however, but instead can be employed generally for reacting and hence for derivatizing all incompletely condensed oligomeric silsesquioxanes with any of a very wide variety of alkoxysilanes, it being possible for the alkoxysilanes to possess one, two, three or four alkoxy groups on the Si atom. The functionalized oligomeric silsesquioxanes formed by the reaction of the invention are not required to have the structure 1, but instead can be either monofunctionalized or polyfunctionalized; they may possess identical or different functional groups X; they may be either completely or incompletely condensed; and they may contain further, free hydroxyl groups. As incompletely condensed silsesquioxanes having a structure differing from the structure 2 it is possible, for example, to use disilanols, tetrasilanols, various incompletely condensed silsesquioxanes having cage structures which differ from cubic T8 building blocks, or incompletely condensed silsesquioxanes which are already functionalized, all of which can now be functionalized by means of the process of the invention, allowing, in turn, any of a very wide variety of structures to form.

For controlling and/or accelerating the reaction it is advantageous to carry out the reaction in the presence of a basic catalyst.

Basic catalysts used are preferably at least those from the group OH⁻, RO⁻, RCOO⁻, RNH⁻, RCONR⁻, R⁻, CO₃²⁻, PO₄³⁻, SO₄²⁻, NO₃⁻, F⁻, NR₃, R₃NO, it being possible for R to be a hydrogen atom, a substituted or unsubstituted alkyl, cycloalkyl, alkenyl, cycloalkenyl, alkynyl, cycloalkynyl, aryl or heteroaryl radical. Particular preference is given to using KOH, NaOH, (C₂H₅)₄NOH, C₆H₅CH₂(CH₃)₃NOH, (CH₃)₄NOH and/or (C₂H₅)₃N as basic catalysts. Very particular preference is given to the use of ammonium hydroxides, such as (C₂H₅)₄NOH, for example, as basic catalyst. The enumeration of these examples is not intended to restrict the invention in any way, since any basic catalyst can be used.

The process of the invention is preferably carried out so that in the reaction solution at the beginning of the reaction the molar ratio of incompletely condensed silsesquioxane to the base that is used is from 1000:1 to 1:1, more preferably from 100:1 to 2:1, and very preferably from 20:1 to 5:1.

It can be advantageous to carry out the reaction according to the invention of incompletely condensed oligomeric silsesquioxanes with alkoxysilanes in solution. As solvent it is possible to use both a polar solvent and an apolar solvent. Preference is given to using alcohols, ketones, aldehydes, ethers, acids, esters, anhydrides, alkanes, aromatics, and nitriles, particular preference being given to using alcohols, ethers, acetone, acetonitrile, benzene and toluene as solvents. Very particular preference is given to the use of THF, acetone, methanol, and ethanol, in particular of THF, as solvent. It will be appreciated that mixtures of these solvents can also be used.

The concentration of the incompletely condensed oligomeric silsesquioxanes, especially the incompletely condensed silsesquioxanes of structure 2, in the reaction solution in the process of the invention is, at the beginning of the reaction, preferably from 0.01 mol/l to 10 mol/l, more preferably from 0.1 mol/l to 2 mol/l, and very preferably from 0.2 to 1 mol/l.

It can be advantageous if the concentration of the alkoxysilane XₘSi(OR′)ₙ in the process of the invention at the beginning of the reaction exceeds the concentration of the incompletely condensed oligomeric silsesquioxane. It is sufficient if the alkoxysilane excess is kept low, although the use of a marked excess of alkoxysilane XₘSi(OR′)ₙ is also possible. At the beginning of the reaction the reaction solution preferably has a molar excess of alkoxysilane, in comparison to the incompletely condensed oligomeric silsesquioxane, of up to 100%, preferably from 0.02 to 20%, more preferably from 0.1 to 5%.

When the process of the invention is being carried out it can be advantageous if water is added to the reaction mixture. In some cases, however, the existing traces of water in the solvent are sufficient or the reaction or the conversion according to the invention takes place without the presence of water at the beginning of the reaction. The molar ratio of water to the incompletely condensed oligomeric silsesquioxane at the beginning of the conversion is preferably from 1000:1 to 0.1:1, more preferably from 100:1 to 0.5:1, very preferably from 10:1 to 1:1.

The process of the invention can be carried out, for example, at temperatures from −50 to 300° C., with a temperature of from 0 to 200° C. being preferred. With particular preference the reaction is carried out at a temperature of from 0° C. to 100° C. It is entirely possible for the temperature to be varied during the conversion according to the invention. Thus, for example, the lowering of the temperature at the end of the reaction, for the purpose of isolating the product as completely as possible, can be advantageous.

The functionalized oligomeric silsesquioxanes prepared in accordance with the invention, and particularly the functionalized oligomeric silsesquioxanes of structure 1 prepared in accordance with the invention, can be used, for example, for further derivatizations, for the synthesis of catalysts and their starting compounds, and for the synthesis and/or modification of polymers. In other words there is a broad field of application for these silsesquioxanes.

The functionalized oligomeric silsesquioxanes of the formula 1 prepared in accordance with the invention can additionally be used for improving the adhesion and bonding properties, the rheological properties and/or the barrier effect for gases and liquids in polyolefins, in amorphous polyalphaolefins, in polyamides, in copolyamides, in polyamide compounds, in polyesters, in copolyesters, in polyacrylates, in polymethacrylates, in polycarbonates, in polyurethanes, in phenolic resins, in epoxy resins, in polysiloxanes, in polysilanes, in rubber, in rubber compounds, in polyvinyl chloride, in vinyl chloride copolymers, in polystyrene, in copolymers of styrene, in ABS polymers and olefin copolymers and terpolymers.

The functionalized oligomeric silsesquioxanes of the formula 1 prepared in accordance with the invention can also be used in paints and printing inks for improving the rheological properties, the settling behavior, the application properties, and the surface properties of the paint or printing ink film.

Since the physical character of the silsesquioxanes on the one hand, via the R group, and the chemical reactivity of the silsesquioxanes on the other hand, via the functional group X, can be varied widely, it is possible to modify all common polymers. The modification of the polymers by the functionalized oligomeric silsesquioxanes may take place by blending, grafting, addition copolymerization, and copolycondensation. In this case the functional group X introduced by the present process of the invention allow the chemical anchoring of the oligomeric silsesquioxane to polymers by grafting, addition copolymerization, and copolycondensation.

By virtue of the modification with suitable oligomeric silsesquioxanes it is possible to exert a favorable influence on the rheological properties, the adhesion and bonding properties, and the barrier effect for gases and liquids in a multiplicity of polymers. Such organic polymers as, for example, polyolefins, polyethers, polyesters, polycarbonates, polyamides, polyurethanes, polyacrylates, polymethacrylates, polysiloxanes, polysilanes, phenolic resins, epoxy resins, polyvinyl chloride and vinyl chloride copolymers, polystyrene and copolymers of styrene, ABS polymers, and rubbers can be modified by blending, grafting, addition copolymerization, and copolycondensation with the functionalized oligomeric silsesquioxanes. The functionalized oligomeric silsesquioxanes can also be used for modifying polymer surfaces on which they are anchored physically or else via the functional groups X chemically. The resultant polymers can find application in the form, for example, of coatings, varnishes, injection moldings or extruded moldings, calendered films, lubricants, adhesives, cosmetics, pharmaceuticals, fibers, including glass fibers, or packaging materials. In addition they can be used as bioactive and fungicidal products, for electronic materials, in aerospace, and for producing medical prostheses.

The use of the functionalized oligomeric silsesquioxanes prepared in accordance with the invention for polymer modification is of advantage since in the resultant polymers they raise the glass temperature, the decomposition temperature, and hence also the service temperature, increase the tensile strength, impact strength, scratch resistance, and mechanical hardness, lower the density, reduce the heat conductivity, the thermal expansion coefficient, and the dielectric constant and the viscosity, alter the surface tension and adhesion, lower the flammability, combustibility and development of heat, raise the O₂ permeability, the oxidation stability, and the corrosion stability, simplify processing, and restrict contraction processes.

The functionalized oligomeric silsesquioxanes obtainable by the process of the invention can be derivatized further by common methods and may also serve as starting compounds for catalysts. In that context they can form, by reaction with metal compounds, homogeneous and heterogeneous catalysts, which in turn can be employed for oxidations, metathesis, C—C coupling reactions, oligomerization, polymerization, additions, reductions, eliminations, rearrangements. Preference is given in this context to reaction with metal compounds of metals of the transition groups, including the lanthanoids and actinoids, and of main groups 3 and 4.

The examples which follow are intended to illustrate the invention without restricting the scope of its protection:

### EXAMPLE 1

### Reaction of (isobutyl)₇Si₇O₉(OH)₃ with 3-chloropropyltrimethoxysilane

2.4 ml (13.2 mmol) of 3-chloropropyltrimethoxysilane are added at 20° C. to a solution of 10.0 g (12.6 mmol) of (isobutyl)₇Si₇O₉(OH)₃ in 20 ml of THF. Following the addition of 0.5 ml of Et₄NOH (35% solution in H₂O, 1.2 mmol of base, 18 mmol of H₂O) the mixture is stirred overnight. The resulting white suspension is admixed with 100 ml of MeOH. Following filtration the residue is washed with two times 50 ml of acetone. This gives 6.0 g (60% yield) of 3 as a white powder.

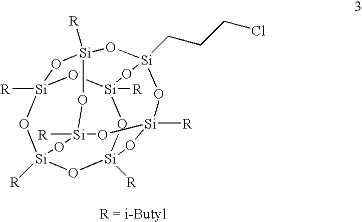

### EXAMPLE 2

### Reaction of (isobutyl)₇Si₇O₉(OH)₃ with Vinyltrimethoxysilane

2.0 ml (13.1 mmol) of vinyltrimethoxysilane are added at 20° C. to a solution of 10.0 g (12.6 mmol) of (isobutyl)₇Si₇O₉(OH)₃ in 20 ml of THF. Following the addition of 0.5 ml of Et₄NOH (35% solution in H₂O, 1.2 mmol of base, 18 mmol of H₂O) the mixture is stirred overnight. The resulting cloudy solution is admixed with 200 ml of MeOH. Following filtration the residue is washed with 30 ml of acetone. This gives 6.1 g (60% yield) of 4 as a white powder.

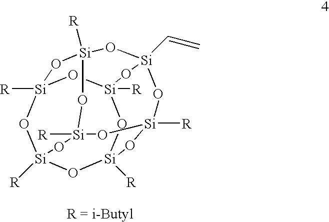

### EXAMPLE 3

### Reaction of (isobutyl)₇Si₇O₉(OH)₃ with 3-aminopropyltrimethoxysilane

3.0 ml (12.8 mmol) of 3-aminopropyltrimethoxysilane are added at 20° C. to a solution of 10.0 g (12.6 mmol) of (isobutyl)₇Si₇O₉(OH)₃ in 20 ml of THF. Following the addition of 0.5 ml of Et₄NOH (35% solution in H₂O, 1.2 mmol of base, 18 mmol of H₂O) the mixture is stirred overnight. The clear solution is subsequently admixed with 200 ml of MeOH. Filtration gives 3.1 g (30% yield) of 5 as a white powder.

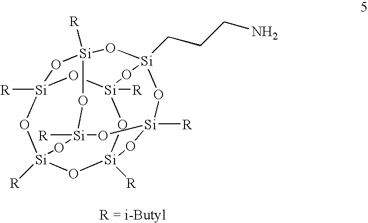

### EXAMPLE 4

### Reaction of (isobutyl)₇Si₇O₉(OH)₃ with N-[3-(trimethoxysilyl)propyl]-ethylenediamine

2.8 ml (12.8 mmol) of N-[3-(trimethoxysilyl)propyl]ethylenediamine are added at 20° C. to a solution of 10.0 g (12.6 mmol) of (isobutyl)₇Si₇O₉(OH)₃ in 20 ml of THF. Following the addition of 0.5 ml of Et₄NOH (35% solution in H₂O, 1.2 mmol of base, 18 mmol of H₂O) the mixture is stirred overnight. The clear solution is subsequently admixed with 200 ml of MeOH. Subsequently the slightly cloudy solution is admixed with 100 ml of acetonitrile. Filtration gives 0.7 g (7% yield) of 6 as a white powder.

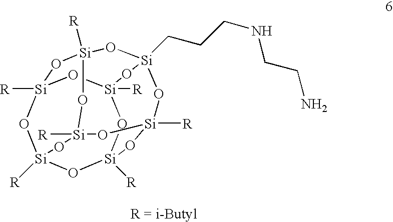

### EXAMPLE 5

### Reaction of (isobutyl)₇Si₇O₉(OH)₃ with 3-(trimethoxysilyl)propyl methacrylate

3.0 ml (12.6 mmol) of 3-(trimethoxysilyl)propyl methacrylate are added at 20° C. to a solution of 10.0 g (12.6 mmol) of (isobutyl)₇Si₇O₉(OH)₃ in 20 ml of THF. Following the addition of 0.5 ml of Et₄NOH (35% solution in H₂O, 1.2 mmol of base, 18 mmol of H₂O) the mixture is stirred overnight. The clear solution is subsequently admixed with 200 ml of MeOH. Following filtration the solid which remains is washed with 30 ml of acetone. This gives 4.0 g (70% yield) of 7 as a white powder.

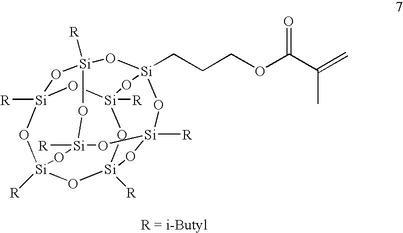

### EXAMPLE 6

### Reaction of (isobutyl)₇Si₇O₉(OH)₃ with Isobutyltrimethoxysilane

2.5 ml of isobutyltrimethoxysilane are added at 20° C. to a solution of 10.0 g (12.6 mmol) of (isobutyl)₇Si₇O₉(OH)₃ in 20 ml of THF. Following the addition of 0.5 ml of Et₄NOH (35% solution in H₂O, 1.2 mmol of base, 18 mmol of H₂O) the mixture is stirred overnight. The resulting, slightly cloudy solution is subsequently admixed with 200 ml of MeOH. Following filtration the solid which remains is washed with 30 ml of acetone. This gives 4.0 g (40% yield) of 8 as a white powder.

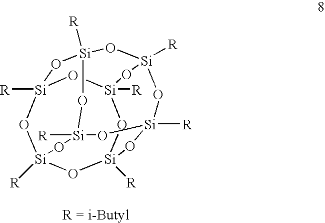

1. A process for preparing functionalized oligomeric silsesquioxanes, which comprises reacting incompletely condensed oligomeric silsesquioxanes with alkoxysilanes under base catalysis and the molar ratio of the incompletely condensed oligomeric silsesquioxane to the basic catalyst is from 1000:1 to 1:1.

2. The process as claimed in claim 1, wherein the compounds of the formula XₘSi(OR′)ₙ are used as alkoxysilanes, where X is a hydrogen, oxy, hydroxyl, alkoxy, carboxyl, silyl, silyloxy, halogen, epoxy, ester, fluoroalkyl, isocyanate, acrylate, methacrylate, nitrile, amino, phosphine group, where—where possible—these radicals X can in turn be further functionalized, and/or a substituted or unsubstituted alkyl, cycloalkyl, alkenyl, cycloalkenyl, alkynyl, cycloalkynyl, aryl, heteroaryl radical which is functionalized with oxy, hydroxyl, alkoxy, carboxyl, silyl, silyloxy, halogen, epoxy, ester, fluoroalkyl, isocyanate, acrylate, methacrylate, nitrile, amino, phosphine groups, R′ is a hydrogen atom, a substituted or unsubstituted alkyl, cycloalkyl, alkenyl, cycloalkenyl, alkynyl, cycloalkynyl, aryl, heteroaryl radical, and m and n can adopt values from 1 to 3, with the proviso that the sum of m and n is 4.

3. The process as claimed in claim 1, wherein functionalized oligomeric silsesquioxanes of structure 1 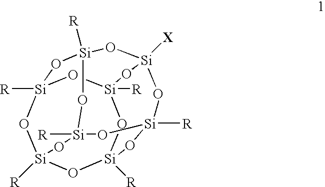
are prepared by reacting incompletely condensed oligomeric silsesquioxanes of structure 2 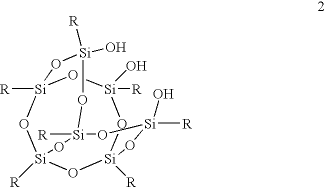
with alkoxysilanes XSi(OR′)₃ under base catalysis,
where X is a hydrogen, oxy, hydroxyl, alkoxy, carboxyl, silyl, silyloxy, halogen, epoxy, ester, fluoroalkyl, isocyanate, acrylate, methacrylate, nitrile, amino, phosphine group, and—where possible—these radicals X may in turn be further functionalized, and/or a substituted or unsubstituted alkyl, cycloalkyl, alkenyl, cycloalkenyl, alkynyl, cycloalkynyl, aryl, heteroaryl radical which is functionalized with oxy, hydroxyl, alkoxy, carboxyl, silyl, silyloxy, halogen, epoxy, ester, fluoroalkyl, isocyanate, acrylate, methacrylate, nitrile, amino, phosphine groups, R is a hydrogen atom, a substituted or unsubstituted alkyl, cycloalkyl, alkenyl, cycloalkenyl, alkynyl, cycloalkynyl, aryl, heteroaryl radical or in all or some cases a group X, and R′ is a hydrogen atom, a substituted or unsubstituted alkyl, cycloalkyl, alkenyl, cycloalkenyl, alkynyl, cycloalkynyl, aryl, heteroaryl radical.

4. The process as claimed in claim 1, wherein as basic catalyst at least one from the group consisting of OH⁻, RO⁻, RCOO⁻, RNH⁻, RCONR⁻, R⁻, CO₃²⁻, PO₄³⁻, SO₄²⁻, NO₃⁻, F⁻, NR₃, and R₃NO is used, it being possible for R to be a hydrogen atom, a substituted or unsubstituted alkyl, cycloalkyl, alkenyl, cycloalkenyl, alkynyl, cycloalkynyl, aryl or heteroaryl radical.

5. The process as claimed in claim 4, wherein KOH, NaOH, (C₂H₅)₄NOH, C₆H₅CH₂(CH₃)₃NOH, (CH₃)₄NOH and/or (C₂H₅)₃N is used as basic catalyst.

6. The process as claimed in claim 5, wherein (C₂H₅)₄NOH is used as basic catalyst.

7. The process as claimed in claim 1, wherein the reaction of incompletely condensed oligomeric silsesquioxanes with alkoxysilanes takes place in solution.

8. The process as claimed in claim 7, wherein halogen-free systems selected from alcohols, ketones, aldehydes, ethers, acids, esters, anhydrides, alkanes, aromatics, and nitriles or mixtures thereof are used as solvents.

9. The process as claimed in claim 8, wherein THF, acetone, methanol, and ethanol or mixtures of these solvents are used as solvents.

10. The process as claimed in claim 9, wherein THF is used as solvent.

11. The process as claimed in claim 7, wherein the concentration of the incompletely condensed oligomeric silsesquioxane in the reaction solution at the beginning of the reaction is from 0.01 mol/l to 10 mol/l.

12. The process as claimed in claim 11, wherein the concentration of the incompletely condensed oligomeric silsesquioxane in the reaction solution at the beginning of the reaction is from 0.2 mol/l to 1 mol/l.

13. The process as claimed in claim 1, wherein the molar ratio of the incompletely condensed oligomeric silsesquioxane to the basic catalyst is from 20:1 to 5:1.

14. The process as claimed in claim 1, wherein the reaction is carried out in the presence of water.

15. The process as claimed in claim 14, wherein the molar ratio of water to the incompletely condensed oligomeric silsesquioxane at the beginning of the reaction is from 1000:1 to 0.1:1.

16. The process as claimed in claim 15, wherein the molar ratio of water that is used to the incompletely condensed oligomeric silsesquioxane is from 10:1 to 1:1.

17. The process as claimed in claim 1, wherein the preparation of the functionalized oligomeric silsesquioxanes is carried out at a temperature of from −50° C. to 300° C.

18. The process as claimed in claim 17, wherein the preparation of the functionalized oligomeric silsesquioxanes is carried out at a temperature of from 0° C. to 100° C.
